(19) United States
(12) Patent Application Publication
(10) Pub. No.: US 2025/0299163 A1
(43) Pub. Date: Sep. 25, 2025

(54) METHOD, APPARATUS, AND PROGRAM FOR APPOINTMENT MANAGEMENT, AND APPOINTMENT MANAGEMENT SYSTEM

(71) Applicant: RISO KAGAKU CORPORATION, Tokyo (JP)

(72) Inventors: Nobuyuki NAKAYAMA, Tokyo (JP); Junko KATO, Tokyo (JP); Yasutaka WATANABE, Tokyo (JP); Kazuaki TAKEI, Tokyo (JP); Hiroharu ITO, Tokyo (JP); Takuya SATO, Tokyo (JP); Yuki IWAMI, Tokyo (JP); Ryosuke ICHIMURA, Tokyo (JP)

(73) Assignee: RISO KAGAKU CORPORATION, Tokyo (JP)

(21) Appl. No.: 19/080,029

(22) Filed: Mar. 14, 2025

(30) Foreign Application Priority Data
Mar. 22, 2024 (JP) 2024-046661
Dec. 4, 2024 (JP) 2024-211844

(51) Int. Cl. G06Q 10/1093

(52) U.S. Cl. CPC G06Q 10/1095

(57) ABSTRACT

An appointment management apparatus includes: an appointment slot setting unit in which a plurality of appointment slots prepared by a host are set in advance; a guest attribute information storage unit that stores attribute information of a plurality of guests who make appointments from among the plurality of appointment slots; a desired appointment slot receiving unit that receives a desired appointment slot selected by each guest from among the candidate appointment slots for each guest; and an assigning unit that assigns an appointment for each guest from among the plurality of appointment slots based on the desired appointment slot of each guest and the attribute information of each guest.

### CROSS-REFERENCE TO RELATED APPLICATIONS

The present application claims priority under 35 U.S.C. § 119 to Japanese Patent Application No. 2024-046661, filed on Mar. 22, 2024 and Japanese Patent Application No. 2024-211844, filed on Dec. 4, 2024. The above applications are hereby expressly incorporated by reference, in these entireties, into the present application.

### BACKGROUND OF THE INVENTION

### 1. Field of the Invention

The present disclosure is related to an appointment management apparatus, an appointment management method, an appointment management program and an appointment management system for assigning guest appointments to appointment slots prepared by a host.

### 2. Description of the Related Art

Conventionally, when a teacher at a school meets with guardians of students, it is necessary to coordinate the date and time of the meeting with all guardians. Generally, all guardians are asked to answer a questionnaire regarding their preferred dates and times, and the school schedules meetings to suit their preferred dates and times.

In this case, there are some guardians with whom meetings should be held earlier in the day from the viewpoint of the school, and there are some guardians with whom meetings should be held in the last slot of the day for longer meetings. Therefore, the schedule needs to be adjusted to take these circumstances into consideration. In addition, it is necessary to send out rescheduling requests to guardians with whom meetings cannot be held on their desired dates. However, it is very time consuming to send such requests and to adjust the schedule after the rescheduling.

Japanese Unexamined Patent Publication No. 2021-170151 proposes a meeting schedule adjustment apparatus that enables adjustment of schedules for interviews between a recruiter and a job seeker to be facilitated. Specifically, Japanese Unexamined Patent Publication No. 2021-170151 proposes an interview schedule adjustment apparatus that identifies a plurality of dates and times when interviews can be held, based on schedule information of the recruiter.

### SUMMARY OF THE INVENTION

However, in Japanese Unexamined Patent Publication No. 2021-170151, the availability of the recruiter (interviewer) is referenced, but the availability of the job seeker (interviewee) is not. Therefore, the interview date is not necessarily convenient for the job seeker, resulting in the problem of frequent rescheduling.

The present disclosure has been developed in view of the foregoing circumstances. The present disclosure provides a method, an apparatus, and a program for appointment management, and an appointment management system capable of reducing the number of rescheduling procedures and efficiently adjusting schedules without an undue burden.

The appointment management apparatus of the present disclosure is equipped with an appointment slot setting unit in which a plurality of appointment slots prepared by a host are set in advance, a guest attribute information storage unit that stores attribute information of a plurality of guests who make appointments from among the plurality of appointment slots, a desired appointment slot receiving unit that receives desired appointment slots from a plurality of guests, and an assigning unit that assigns an appointment for each guest from among the plurality of appointment slots based on the desired appointment slot of each guest and the attribute information of each guest.

According to the appointment management apparatus of the present disclosure, the appointment management apparatus assigns appointment slots for each guest from among a plurality of appointment slots based on the attribute information of each guest. Therefore, the number of times of rescheduling procedures be reduced and a schedule can be adjusted efficiently and without an undue burden.

### BRIEF DESCRIPTION OF THE DRAWINGS

FIG. 1 is a block diagram that illustrates the schematic configuration of an appointment management system employing an embodiment of the appointment management apparatus of the present disclosure.

FIG. 2 is a diagram that illustrates an example of preset appointment slots.

FIG. 3 is a diagram that illustrates an example of an attribute information table that shows attribute information of each guardian.

FIG. 4 is a diagram that illustrates an example of desired appointment slots for each guardian.

FIG. 5 is a diagram that illustrates an example of a schedule with appointments assigned to each guardian from among a plurality of appointment slots.

FIG. 6 is a sequence diagram for explaining the flow of processes performed by the appointment management system illustrated in FIG. 1.

FIG. 7 is a flow chart for explaining a method for assigning appointments that prioritizes degrees of priority over desired appointment slots of guardians.

FIG. 8 is a flow chart for explaining a method for assigning appointments evenly from among all appointment slots for guardians who specify arbitrary dates and times.

FIG. 9 is a diagram that illustrates an example of a meeting adjusting screen.

FIG. 10 is a flowchart for explaining subroutine A in the flow chart illustrated in FIG. 8.

FIGS. 11A and 11B are a collection of diagrams that illustrate examples of appointment slots and second choice desired appointment slots of guardians.

FIG. 12 is a diagram that illustrates a state in which desired appointment slots are preliminarily assigned for guardians of students having attendance numbers 22 through 25.

FIG. 13 is a diagram that illustrates a state in which an appointment is assigned for a guardian of a student having attendance number 21.

FIG. 14 is a diagram that illustrates a state in which desired appointment slots are preliminarily assigned for guardians of students having attendance numbers 23 through 25.

FIG. 15 is a diagram that illustrates a state in which an appointment is assigned for a guardian of a student having attendance number 22.

FIG. 16 is a diagram that illustrates in which desired appointment slots for guardians of students having attendance numbers 24 and 25 are preliminarily assigned.

FIG. 17 is a diagram that illustrates a state in which an appointment is assigned for a guardian of a student having student attendance number 23.

FIG. 18 is a diagram that illustrates a state in which a desired appointment slot is preliminarily assigned for a guardian of a student having attendance number 25.

FIG. 19 is a diagram that illustrates a state in which an appointment is assigned for a guardian of a student having attendance number 24.

FIG. 20 is a diagram that illustrates desired appointment slots for the guardian of the student having attendance number 25.

FIG. 21 is a diagram that illustrates a state in which an appointment is assigned to the guardian of the student having attendance number 25.

FIG. 22 is a flow chart for explaining a method for assigning appointments that prioritizes desired appointment slots over degrees of priority of guardians.

FIG. 23 is a flow chart for explaining a case in which subroutine A is executed in the method for assigning appointments that prioritizes desired appointment slots over degrees of priority of guardians.

FIG. 24 is a flow chart for explaining a case in which subroutine A is executed in the method for assigning appointments by giving priority to the desired appointment slots of guardians over the degrees of priority of the guardians.

### DETAILED DESCRIPTION OF THE EMBODIMENTS

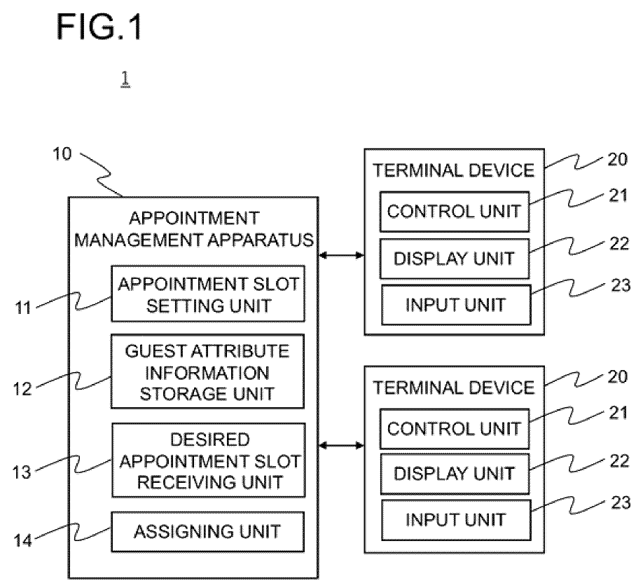

An appointment management system that employs an embodiment of an appointment management apparatus of the present disclosure will be described in detail below with reference to the drawings. FIG. 1 is a block diagram that illustrates the schematic configuration of an appointment management system 1 of the present embodiment.

The appointment management system 1 of the present embodiment is a system for scheduling meetings between school teachers and guardians of students who attend the school. The appointment management system 1 is equipped with an appointment management apparatus 10 and terminal devices 20 of the guardians. Only two terminal devices 20 of the guardians are illustrated in FIG. 1. However, in reality, many terminal devices 20 of the guardians are connected to one appointment management apparatus 10.

The appointment management apparatus 10 and the terminal devices 20 of the guardians are connected by a communication network such as the Internet such that they are capable of communicating with each other.

The appointment management system 1 of the present embodiment is a system that stores attribute information of each of the guardians which is known by the school, and assigns an appointment to each of the guardians based on the attribute information and desired appointment slots of each of the guardians from among a plurality of preset appointment slots. In the present embodiment, the school (teacher) corresponds to the host of the present disclosure, and the guardians correspond to the guests of the present disclosure.

The following is a detailed description of each of the components that constitute the appointment management system 1 of the present embodiment.

The appointment management apparatus 10 has an appointment slot setting unit 11, a guest attribute information storage unit 12, a desired appointment slot receiving unit 13, and an assigning unit 14.

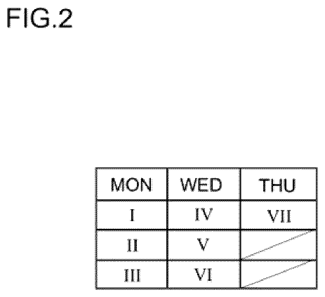

A plurality of appointment slots which are prepared by the school (teacher) are set in advance in the appointment slot setting unit 11. The appointment slots are set and entered, for example, on a terminal device (not shown) owned by a teacher, and set in the appointment slot setting unit 11. FIG. 2 illustrates an example of available appointment slots. In FIG. 2, three appointment slots (I to III) are set for Monday, three appointment slots (IV to VI) are set for Tuesday, and one appointment slot (VII) is set for Thursday.

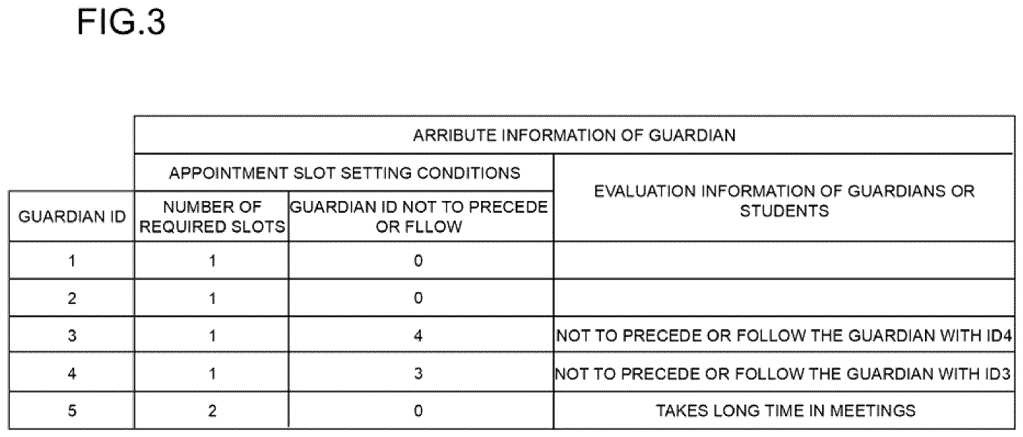

The guest attribute information storage unit 12 stores attribute information of multiple guardians who make appointments from among a plurality of appointment slots. FIG. 3 illustrates an example of an attribute information table in which guardian IDs are correlated to the attribute information of guardians. The guardian IDs are identification information assigned to each guardian.

As illustrated in FIG. 3, the present embodiment stores evaluation information regarding the guardians and students and appointment slot setting conditions set based on the evaluation information as the attribute information of the guardians.

The evaluation information regarding the guardians includes information regarding evaluations of the guardians from the viewpoint of the school (teachers), information regarding personal relationships of the guardians, and information regarding the employment status of the guardians, for example.

Information regarding the evaluation of guardians from the viewpoint of the school (teachers) includes information such as “takes a long time in meetings” and “not punctual” (likely to be late for meetings), for example. In addition, information regarding the personal relationships of the guardians includes information regarding guardians who should not have their appointment slots immediately preceding or following each other, for example.

The evaluation information regarding students includes the student's academic performance and information regarding whether the student has siblings within the same school. In the case that the student's academic performance is poor, the “meeting will take longer”, and if the student has siblings within the same school, the appointment slots for the siblings should be arranged on the same day, or the appointment slots should immediately precede or follow each other.

Information regarding the employment status of the guardians includes information such as the type of work the guardians do and whether both parents (guardians) are employed.

Note that in FIG. 3, information that indicates “meeting will take longer” and information regarding guardians who should not have appointment slots immediately preceding or following each other are set as the evaluation information regarding guardians and students. However, other types of evaluation information may be included as well.

The appointment slot setting conditions are conditions for setting appointment slots which are set based on the evaluation information regarding guardians and students as described above. In the present embodiment, the number of required slots and the guardian ID's of guardian for whom appointment slots should not immediately precede or follow each other are stored as the appointment slot setting conditions.

The number of required slots indicates the number of appointment slots needed for one meeting. The number of required slots is usually “1” and the number of required slots increases depending on the evaluation information regarding the guardians and the student. For example, if the evaluation information regarding the guardian indicates that the meeting will take time, or if the student's evaluation information indicates that there is a problem with his/her academic performance, the meeting will require more time, so the number of required slots will be set to a plurality of slots.

The guardians whose appointment slots are not to precede or follow each other indicates the guardian IDs of guardians whose appointment slots can not precede or follow each other. For example, in the example of the attribute information table illustrated in FIG. 3, the evaluation information of the guardian with guardian ID 3 is “not to precede or follow the guardian with ID 4”. The guardian ID “4” is stored as a guardian ID not to precede or follow the guardian with ID 3, and the guardian ID “3” is stored as a guardian ID not to precede or follow the guardian with ID 4.

The desired appointment slot receiving unit 13 receives a desired appointment slot from each guardian which is output from the terminal device 20 of each guardian. The guardians confirm the appointment slots which are set in the appointment slot setting unit 11 on their terminal devices 20, selects desired appointment slots from among the set appointment slots, and outputs their desired appointment slots to the appointment management apparatus 10.

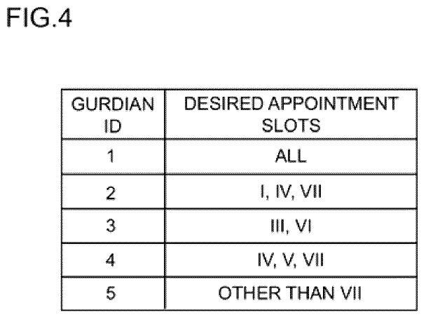

FIG. 4 is a diagram that illustrates an example of desired appointment slots for each of guardians having guardian ID's ID 1 through ID 5. In the example illustrated in FIG. 4, the guardian having guardian ID 1 selected “ALL”, which means that appointment slots at any date or time are acceptable to them. The guardian having guardian ID 2 selected appointment slots I, IV, and VII, and therefore it can be understood that they desire the first appointment slot on each date. The guardian having guardian ID 3 selected appointment slots III and VI, and therefore it can be understood that they desire the last appointment slot on each date. The guardian having guardian ID 4 selected appointment slots IV, V, and VI, and therefore it can be understood that they desire an appointment on Wednesday. The guardian having guardian ID 5 selected appointment slots other than appointment slot VII, and therefore it can be understood that they desire an appointment on a day of the week other than Thursday.

The assigning unit 14 assigns an appointment to each guardian from among a plurality of appointment slots based on the attribute information of the guardians to complete an ultimately determined appointment schedule and the desired appointment slot for each of the guardians.

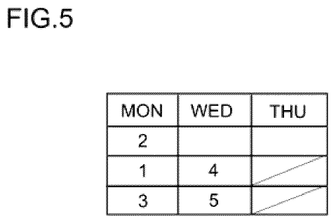

Here, a method for determining an appointment slot for each guardian in the appointment slots illustrated in FIG. 2 by referring to the attribute information table illustrated in FIG. 3 and the desired appointment slots of the guardians illustrated in FIG. 4 will be described. FIG. 5 is a diagram that illustrates an example of a completed appointment schedule.

The assigning unit 14 first assigns appointment slots for the guardians for whom “meetings take time”. In the example of the attribute information table illustrated in FIG. 3, the attribute information of the guardian having guardian ID 5 indicates that “meetings take time” and the number of necessary slots is “2”. In addition, the desired appointment slots of the guardian having guardian ID 5 illustrated in FIG. 4 are slots other than appointment slot VII. Therefore, the assigning unit 14 identifies “last” appointment slots which do not have restrictions on time based on the attribute information of the guardian having guardian ID 5, and further identifies the last appointment slots III and VI on Monday and Wednesday based on the desired appointment slots. Next, the assigning unit determines appointment slot III or appointment slot VI as the appointment slot for the guardian having guardian ID 5. In the example illustrated in FIG. 5, appointment slot VI is determined as the appointment slot for the guardian having guardian ID 5.

Next, the assigning unit 14 assigns an appointment slot for guardians whose desired appointment slots are the first slot of each date. In the desired appointment slots illustrated I in FIG. 4, the guardian having guardian ID 2 desires the first slot of each date. Therefore, the assigning unit 14 identifies appointment slots I, IV, and VII as appointment slots for the guardian having guardian ID2. Next, the assigning unit 14 determines one of appointment slots I, IV, and VII as the appointment slots for the guardian having guardian ID 2. In the example illustrated in FIG. 5, appointment slot I is determined as the appointment slot for the guardian having guardian ID 2.

Next, the assigning unit 14 then determines appointment slots for guardians who are not to have appointments preceding or following each other. In the example of the attribute information table illustrated in FIG. 3, the guardian having guardian ID 3 and the guardian having guardian ID 4 are set as “guardians who are not to have appointments preceding or following each other”. In addition, the desired appointment slots for the guardian having guardian ID 3 illustrated in FIG. 4 are the last appointment slots III and VI. However, appointment slot VI has already been determined to be the appointment slot for the guardian having guardian ID 5.

Therefore, first, the assigning unit 14 determines appointment slot III as the appointment slot for the guardian having guardian ID 3. Next, the assigning unit 14 determines an appointment slot that does not precede or follow appointment slot III as the appointment slot for the guardian having guardian ID 4. The desired appointment slots for the guardian having guardian ID 4 are appointment slots IV, V, and VI on Wednesday. Appointment slot VI has already been determined to be the appointment slot for the guardian having guardian ID 5. Therefore, the assigning unit 14 determines appointment slot IV or appointment slot V as the appointment slot for the guardian having guardian ID 4. In the example illustrated in FIG. 5, appointment slot V is determined as the appointment slot for the guardian having guardian ID 4.

Nest, the assigning unit 14 determines appointment slots for guardians for whom any date is available last. The guardian having guardian ID 1 is available on any date based on their attribute information and desired appointment slots. Therefore, the assigning unit 14 determines appointment slot II, appointment slot IV, or appointment slot VII as the appointment slot for the guardian having guardian ID 1. In the example illustrated in FIG. 5, appointment slot II is determined as the appointment slot for the guardian having guardian ID 1.

After appointment slots are assigned to all of the guardians, the assigning unit 14 sends the ultimately determined appointment slots for each of the guardians to the terminal device 20 of each guardian. Note that in the case that the evaluation information regarding a student indicates that the student has siblings in the same school, the assigning unit 14 assigns appointment slots for the siblings on the same date, or assigns preceding or following appointment slots for the siblings.

Here, as a result of assignments by the assigning unit 14 based on the attribute information and the desired appointment slots of the guardians as described above, some guardians may not be assigned to their desired appointment slots. In such cases, the assigning unit 14 notifies the terminal devices 20 of such guardians of a request to change their desired appointment slot. When notifying the terminal devices 20 of the guardians of the request for a change, the assigning unit 14 outputs information regarding available appointment slots together with the request.

The guardian then selects desired appointment slots again from among the available appointment slots and sends the reselected desired appointment slots to the appointment management apparatus 10.

The assigning unit 14 reassigns the appointment slots to the available slots based on the changed desired appointment slots. The assigning unit 14 repeats the notification of requests for change and reassignment until the assignment of appointment slots to all of the guardians is completed.

In addition, the assigning unit 14 may set priority appointment information for the guardian ID of a guardian who has changed their desired appointment slot as described above, such that the guardian will be given priority when assigning appointment slots for a next and subsequent meetings. The assigning unit 14 may then assign a desired appointment slot having the highest degree of priority when assigning appointment slots for a next and subsequent meetings to the guardian with the guardian ID for whom the priority appointment information has been set.

The appointment management apparatus 10 is equipped with a CPU (Central Processing Unit), a semiconductor memory such as a ROM (Read Only Memory) and a RAM (Random Access Memory), a storage such as a hard disk, and a communication I/F (Interface).

An appointment management program, which is a web application, is installed in the storage of the appointment management apparatus 10. When this appointment management program is launched by the CPU, the functions of each component of the appointment management apparatus 10 are executed.

Note that some or all of the functions of the appointment management program may be executed by an ASIC (Application Specific Integrated Circuit), an FPGA (Field Programmable Gate Array), or hardware such as other electrical circuits.

The terminal device 20 of the guardian is equipped with a control unit 21. The control unit 21 controls the entirety of the terminal device 20. Particularly, the control unit 21 displays appointment slots which are output from the appointment management apparatus 10 on a display unit 22, and sends desired appointment slots which have been set and input at an input unit 23 to the appointment management apparatus 10.

The display unit 22 is constituted by a display device such as a liquid crystal display, and the input unit 23 is constituted by an input device such as a mouse or a keyboard.

Note that in the case that a tablet terminal or a smartphone is employed as the terminal device 20, the touch panel of the tablet terminal or the smartphone functions as both the display unit 22 and the input unit 23.

The terminal device 20 is equipped with a CPU, a semiconductor memory such as a ROM and a RAM, a storage such as a hard disk, and a communication I/F.

An application for guardians is installed in the storage of the terminal device 20. When this application for guardians is launched by the CPU, appointment slots are displayed on the terminal device 20, and desired appointment slots can be set and input. Note that an application for guardians which is provided via a web browser may be utilized instead of the application for guardians which is installed on the storage device as in the present embodiment.

In addition, some or all of the functions of the application for guardians may be executed by hardware such as an ASIC, an FPGA, or other electrical circuits.

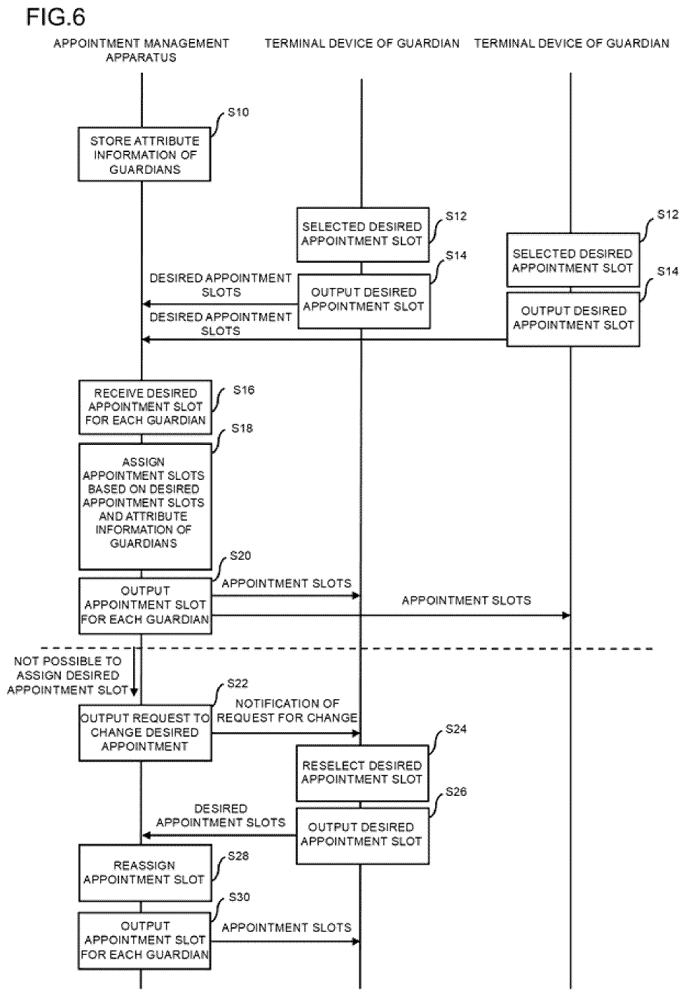

Next, the flow of processes performed by the appointment management system 1 of the present embodiment will be explained with reference to the sequence diagram illustrated in FIG. 6.

First, attribute information for each guardian as illustrated in FIG. 3 is stored at the appointment management apparatus 10 (S10).

Next, appointment slots which are output from the appointment management apparatus 10 are confirmed by each guardian at their terminal device 20, desired appointment slots are selected from among the appointment slots (S12), and the selected desired appointment slots are output to the appointment management apparatus 10 (S14).

The appointment management apparatus 10 receives the desired appointment slots which are output from the terminal device 20 of each guardian (S16), and assigns an appointment slot to each of the guardians based on the desired appointment slots which are output from the terminal device 20 of each guardian and the attribute information of each guardian (S18).

The appointment management apparatus 10 then outputs the appointment slots which are assigned to each guardian to the terminal device 20 of each guardian (S20).

Note that in the case that as a result of assignments based on the attribute information of the guardians and the desired appointment slots of the guardians described above, the appointment management apparatus 10 is unable to assign a desired appointment slot to a guardian, the appointment management apparatus 10 notifies the terminal device 20 of the guardian of a request to change the desired appointment slot (S22).

The guardian then reselects a desired appointment slot again from available appointment slots (S24) and outputs the desired appointment slot to the appointment management apparatus 10 (S26).

Then, the appointment management apparatus 10 repeats the notification of requests for change and reassignment until the assignment of appointment slots to all of the guardians is completed (S28).

When the assignment of appointment slots to all of the guardians is completed, the appointment management apparatus 10 outputs the appointment slots for each guardian to each of the terminal devices 20 of the guardians (S30).

According to the appointment management system 1 of the above embodiment, an appointment for each guardian is assigned from among a plurality of appointment slots based on the desired appointment slot of each guardian and the attribute information of each guardian. Thereby, the number of rescheduling procedures can be reduced, and schedules can be adjusted efficiently without an undue burden.

In addition, in the appointment management system 1 of the above embodiment, the terminal devices 20 of guardians to whom desired appointment slots cannot be assigned are notified of a request to change their desired appointment slot. Appointment slots are reassigned for such guardians based on the desired appointment slot which is changed in response to the request for a change, and the notification of the request for a change and reassignment are repeated until the assignment of appointment slots to all of the guardians is completed. Therefore, appointment slots can be positively assigned to each guardian and desired appointment slots can be efficiently assigned to each guardian.

Further, in the appointment management system 1 of the above embodiment, in the case that priority appointment information is added to a guardian who changed their desired appointment slot to give priority in assigning appointment slots for a next and subsequent meetings, the system can provide an advantage to guardian who change their desired appointment slot. Therefore, changes in desired appointment slots by guardians can be conducted more smoothly.

Still further, in the appointment management system 1 of the above embodiment, the attribute information of the guardian is set based on the evaluation of the guardian or student. Therefore, the evaluation of the guardian from the viewpoint of the school can be reflected in the assignment of appointment slots, and more appropriate scheduling can be conducted.

In addition, in the appointment management system 1 of the above embodiment, a necessary number of slots and guardian IDs for which appointments are not to precede or follow each other are set as attribute information of guardians as described above. However, the present disclosure is not limited to such a configuration, and degrees of priority of guardians may be set as the attribute information of guardians, and the degrees of priority may be employed to assign appointments.

The degrees of priority may be set and input employing a terminal device (not shown) by a teacher who is to conduct meetings, and stored in advance in the guest attribute information storage unit 12.

The degrees of priority are set from information regarding evaluations of the guardians from the viewpoint of the school (teachers), information regarding personal relationships of the guardians, information regarding the employment status of the guardians, and the presence or absence of siblings, for example. The degrees of priority are set as numerical values 1, 2, and 3, or as alphabetic letters A, B, and C according to the degree of priority (high, medium, and low), for example.

There are two methods of assigning appointments employing degrees of priority. One method assigns appointments with an emphasis on degrees of priority over the desired appointment slots of the guardians, and the other method assigns appointments with an emphasis on the desired appointment slots of the guardians over degrees of priority.

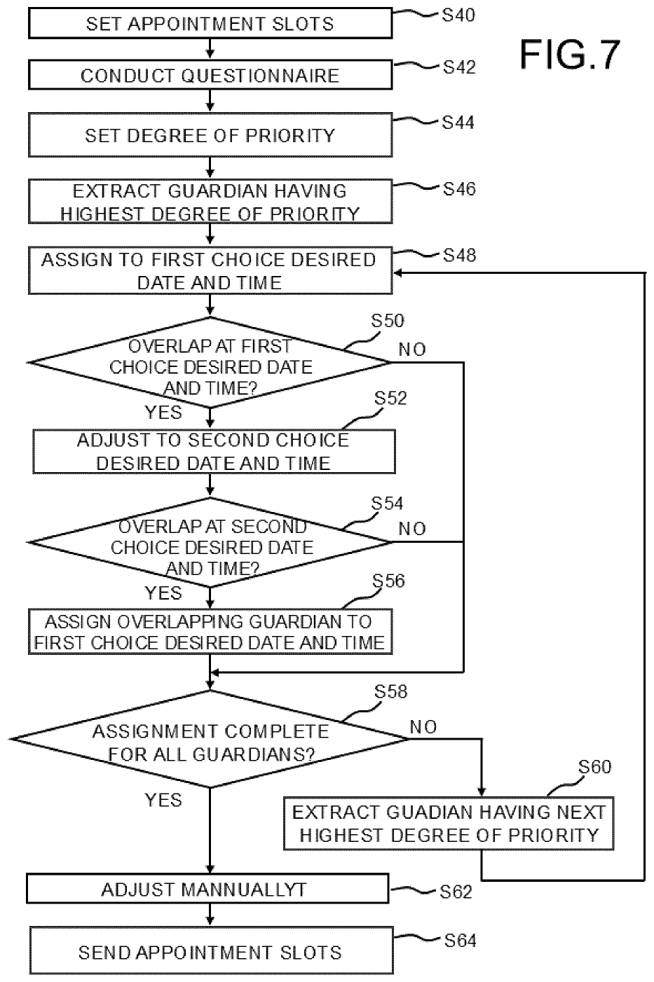

First, the method of assigning appointments with an emphasis on the degree of priority set for each guardian will be explained with reference to the flow chart illustrated in FIG. 7.

First, appointment slots are set by the school (teacher) (S40), and the guardians select desired appointment slots from among the appointment slots by a questionnaire being answered by the guardians (S42). The questionnaire is sent, for example, by sending a questionnaire to the terminal devices 20 of the guardians, and a first and a second choice of date and time are selected as the desired appointment slots. In addition to the selection of the desired appointment slot (desired date and time), the questionnaire also displays, for example, a remarks column, in which the guardian/guardian can enter information to be communicated to the teacher.

For example, preferences of the guardians such as “I would like to make an appointment on or after 3:00 p.m. on the ______day of the month ______”, “I am only available on the date and time of my desired appointment slot”, “I would like to make an appointment for my child's sibling on the same day”, “I would like my appointment to be as early as possible”, and “I would like my appointment to be as late as possible” can be entered as the information to be communicated.

The teacher then displays the results of the questionnaire answered by each guardian employing a terminal device (not shown) and sets a degree of priority for each guardian based on the contents of the desired appointment slot and the remarks column (S44). The degrees of priority set by the teacher are stored in advance in the guest attribute information storage unit 12. In addition, the degrees of priority are also received and stored by the desired appointment slot receiving unit 13 for each guardian.

Next, the assigning unit 14 assigns an appointment for each guardian to an appointment slot based on the degree of priority of each guardian stored in the guest attribute information storage unit 12. Specifically, the assigning unit 14 first extracts a guardian with the highest degree of priority (S46). Then, the assigning unit 14 identifies the first choice date and time of the extracted highest-priority guardian and assigns the appointment to the first choice date and time (S48).

Then, the assigning unit 14 determines whether guardians overlap in the first choice date and time of the guardian with the highest degree of priority (S50). In the case that there is overlap (S50, YES), the assigning unit 14 identifies the second choice dates and times of overlapping guardians and makes adjustments with respect to the second choice dates and times (S52). Specifically, if the second choice date and time of a overlapping guardian is available, the assigning unit 14 assigns an appointment for that guardian at their second choice date and time. At this time, if the second choice dates and times of all overlapping guardians are available, one of the guardians is assigned to their first choice date and time, and the other guardians are assigned to their second choice dates and times. A guardian of a student having the lowest student attendance number can be assigned to their first choice date and time, for example. Note that in the case that there is no overlap among multiple guardians in S50 (S50, NO), the process proceeds to S58 to be described below.

Then, the assigning unit 14 determines whether there is overlap among the guardians in the case that appointments are assigned at the second choice dates and times in S52 (S54), and if there is overlap among a plurality of guardians (S54, YES), appointments are reassigned for the overlapping guardians at their first choice dates and times as provisional appointments (S56). That is, at this point in time, a plurality of guardians have overlapping first choice desired dates and times. Note that the case in which a plurality of guardians overlap in S54 may be a case in which an appointment has already been assigned for the second choice date and time of a guardian as a first choice date and time for another guardian, or a case where the second choice dates and times overlap among guardians. In the case that the second choice dates and times overlap among guardians, an appointment for one of the guardians is assigned to their second choice date and time, and an appointment for the other guardians is reassigned to their first choice date and time. In addition, in the case that in S54, there is no overlap among a plurality of guardians (S54, NO), the process proceeds to S58.

Next, the assigning unit 14 determines whether assignment of appointments for all guardians is complete (S58), and if not (S58, NO), the guardian having the next highest degree of priority is extracted (S60). The assigning unit 14 then replaces the guardian having the highest degree of priority with the guardian having the next highest degree of priority and repeats the processes from S48 to S56.

The assigning unit 14 then determines whether assignment of appointments for all guardians is complete (S58), and if not (S58, NO), the guardian having the third highest degree of priority is extracted (S60). The assigning unit 14 then replaces the guardian having the highest degree of priority with the guardian having the third highest degree of priority and repeats the processes from S48 to S56.

The assigning unit 14 repeats the processes from S48 to S58 until it is determined at S58 that assignment of appointments for all guardians is complete.

In the case that appointments have been assigned for all of the guardians is complete in S58 (including the provisional appointment assignments described above) (S58, YES), the assigning unit 14 identifies appointment slots at which appointments for a plurality of guardians overlap, and displays such appointment slots on the terminal device of the teacher to prompt manual adjustment. The teacher then employs the terminal device to manually adjust the appointment slots such that the overlapping appointment slots are eliminated (S62).

The assigning unit 14 then sends the appointment slots assigned to each of the terminal devices 20 of the guardians (S64).

By assigning appointments with emphasis on degrees of priority given to guardians in the manner described above, the scheduling of appointments can be done with priority given to the wishes of the school (teacher).

Note that in the case that a guardian is not assigned to a given appointment slot in the scheduling according to the flow chart illustrated in FIG. 7, all appointments for the guardians are manually adjusted by the teacher employing their terminal device.

The above is a description of scheduling for a case in which guardians specify a first choice date and time and a second choice date and time as their desired appointment slots. However, there are cases in which a guardian does not specify a specific date and time, but rather specifies that any date and time in the appointment slots is acceptable, such as “ALL” as described above. A method of assigning appointments for guardians who have not specified a specific date or time is to place them in appointment slots from the earliest date or time, for example. However, this method has a problem that the appointment slots at the beginning of the schedule are relatively filled, resulting in bias that prevents appointments from being assigned evenly throughout the entire schedule. In addition, when such a bias occurs, there is a problem that the wishes of guardians who desire the dates and times in which the bias occurs are not fulfilled.

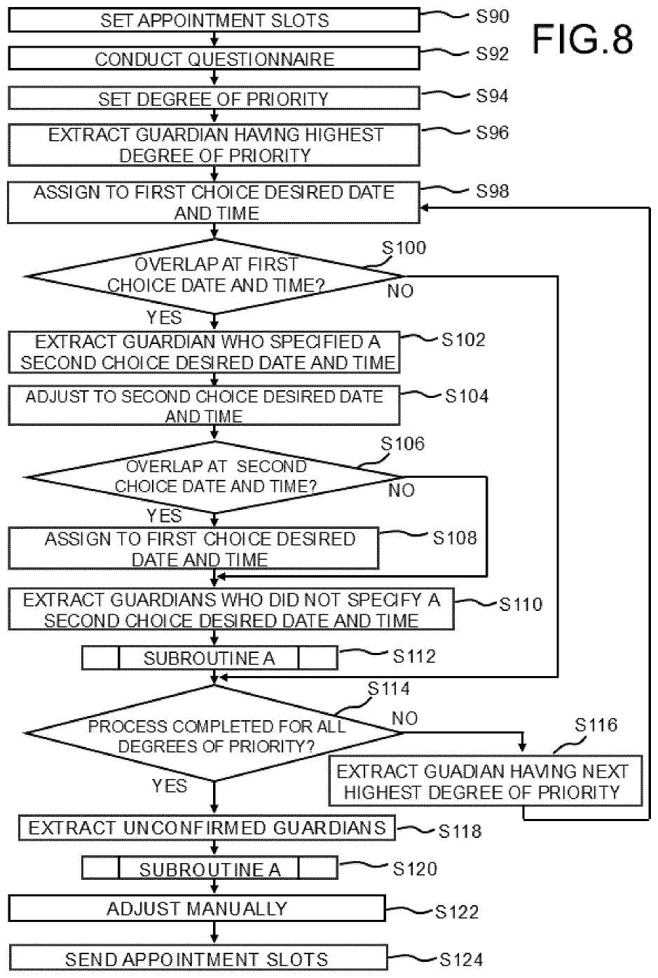

Therefore, a method that assigns appointments evenly throughout the entirety of appointment slots for guardians who have not specified a specific date or time will be described with reference to the flow chart illustrated in FIG. 8.

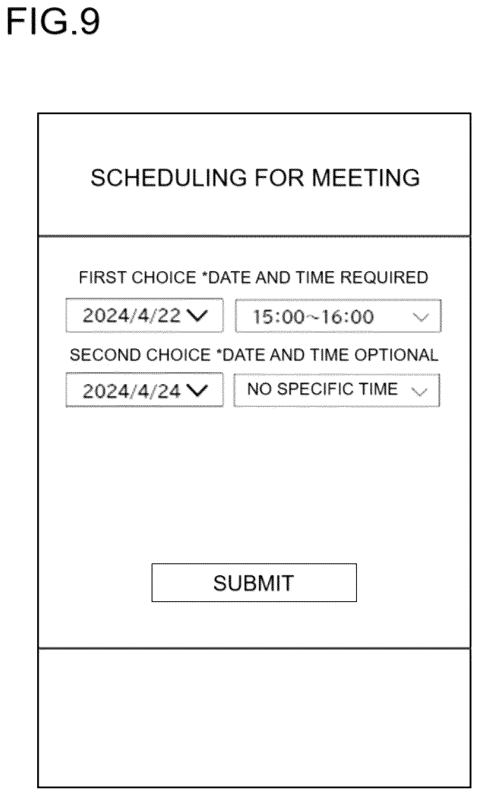

First, the processes from setting the appointment slots to assigning appointments to the first choice date and time of a guardian having the highest degree of priority (S90 to S98) are the same as S40 to S48 in the flow chart illustrated in FIG. 7. However, in the conducting of a questionnaire in S92, the guardian specifies a specific date and time for the first choice, but may select “no specific date” or “no specific time” for the second choice. FIG. 9 illustrates an example of a meeting adjusting screen that is displayed on the terminal device 20 of a guardian, where “no specific date” or “no specific time” can be selected.

In the meeting adjusting screen illustrated in FIG. 9, specific dates and times are displayed as being input for the first choice. The dates and times of appointment slots are set as pull down menus in advance, and the guardian selects one of the dates and times. For the second choice, the date and time of an appointment slot can be selected in the same manner as the first choice, as well as “no specific date” and “no specific time” as described above. In the case that the guardian desires an appointment for a meeting on any date, “no specific date” is selected, and if the guardian desires an appointment for a meeting at any time, “no specific time” is selected. The guardian may select “no specific date” only for the date and “no specific time” only for the time.

After extracting the guardian having the highest degree of priority in S96, the assigning unit 14 identifies the first choice date and time of the guardian having the highest degree of priority and assigns the appointment to their first choice date and time (S98). Then, the assigning unit 14 determines whether there is any overlap among guardians when the appointment is assigned to the first choice date and time of the guardian having the highest degree of priority (S100). Here, overlapping among guardians means that there are two or more guardians that desire a single appointment slot in the case that one guardian is assigned for one appointment slot, or that there are more than four guardians that desire a single appointment slot in the case that four guardians are assigned for one slot.

In the case that there is no overlap among guardians when an appointment is assigned to the first choice date and time (S100, NO), the assigning unit 14 assigns the appointment at the first choice date and time to the guardian having the highest degree of priority, and then proceeds to S114 to be described below.

In contrast, if there is an overlap among guardians when an appointment is assigned for the first choice date and time (S100, YES), the assigning unit 14 confirms the second choice dates and times of the overlapping guardians, calculates the number of remaining slots (number of persons) for appointments for the second choice dates and times specified by each guardian, identifies the guardian with the lowest total number of remaining slots (number of persons), and assigns an appointment for the first choice date and time to the identified guardian. Note that when calculating the remaining number of slots (number of persons) for the second choice date and time specified by each guardian, in the case that “no specific date” or “no specific time” is selected as the date or time, all applicable slots will be added to the number of remaining slots (number of persons).

The assigning unit 14 then extracts the guardians who were not assigned a appointment at the date and time of their first choice in the processes of S98 through S100, and who have specified both a specific date and time as their second choices (S102). The assigning unit 14 then adjusts appointments at the second choice dates and times for such extracted guardians (S104).

Specifically, the assigning unit 14 determines whether there is overlap among guardians when appointments are assigned to the second choice dates and times of the guardians extracted in S102 (S106).

In the case that there is no overlap among guardians when the appointments are assigned to the second choice dates and times (S106, NO), the assigning unit 14 assigns the appointments at the second choice dates and times to the guardians extracted in S102, and then proceeds to S110 to be described below.

In contrast, in the case that there is overlap among the guardians extracted in S102 when appointments are assigned to the second choice dates and times (S106, YES), the assigning unit 14 assigns appointments to the overlapping guardians again at their first choice dates and times as provisional appointments (S108). That is, the state at this point is that in which a plurality of guardians overlap at their first desired dates and times. Note that cases in which a plurality of guardians overlap in S106 include a case in which a guardian has already been assigned an appointment for their first choice date and time which the second choice date and time of another guardian, and a case where the second choice date and time overlaps among guardians. If the second choice dates and times overlap among guardians, the appointment for one of the guardians will be assigned to their second choice date and time, and appointments for the other guardians will be reassigned to their first choice dates and times.

That is, for guardians who have specified specific dates and times for their first choice and their second choice at the stage of processes up to S108, the assigning unit 14 assigns appointments at the date and time of their first or second choice (including provisional appointments at the first date and time).

Next, the assigning unit 14 extracts guardians who have not been assigned an appointment at their first choice date and time and who have not specified a specific date or time as their second choice, based on the results of the guardian questionnaire (S110). That is, the assigning unit 14 extracts guardians who selected “no specific date” or “no specific time” as their second choice on the meeting adjusting screen. At this time, guardians who selected both “no specified date” and “no specified time” are not extracted. Guardians who selected both “no specific date” and “no specific time” will be given a lower degree of priority for appointments, and appointments for such guardians are assigned after appointments for guardians who selected “no specific date” or “no specific time” are determined.

Then, the assigning unit 14 performs subroutine A to assign appointments for the guardians who selected “no specific date” or “no specific time” extracted in S110 (S112).

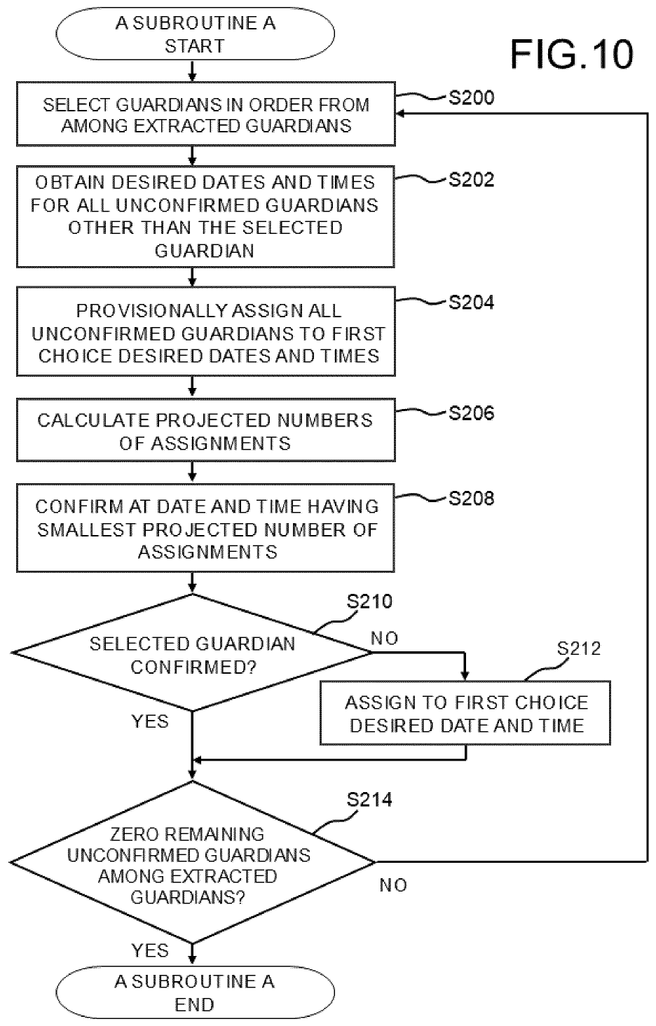

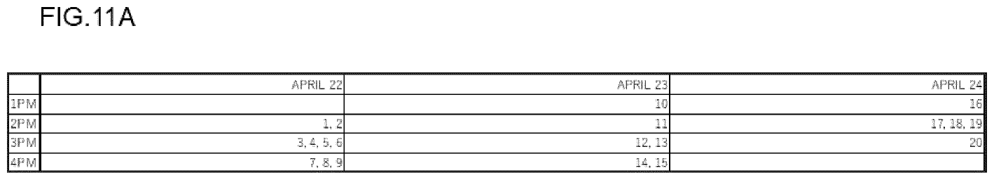

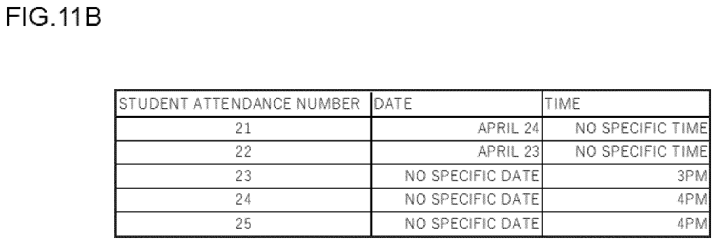

The process of subroutine A will be explained with reference to the flow chart illustrated in FIG. 10. Note that here, a case will be described in which three days (4/22, 4/23, and 4/24) are set as the dates for the appointment slots, 1:00 pm, 2:00 pm, 3:00 pm, and 4:00 pm are set as the times for the appointment slots, and appointments for four guardians can be assigned for one appointment slot, as illustrated in FIG. 11A. FIG. 11A illustrates a state in which the processes up to S108 described above has been completed for a case in which appointments for guardians of students having attendance numbers from 1 to 25 are assigned. The numbers in the table in FIG. 11A are the student attendance numbers of the guardians (students).

In addition, here, it is assumed here that guardians of students having attendance numbers 1 through 20 have specified specific dates and times as their second choices, and that guardian of students having attendance numbers 21 through 25 have selected “no specific date” or “no specific time” as their second choices. FIG. 11b illustrates an example of the second choices of guardians of students having attendance numbers from 21 to 25. Subroutine A assigns appointments for guardians of students having attendance numbers 21 through 25.

First, the assignment unit 14 selects predetermined guardians in order from among the guardians extracted in S110 (S200). Note that here, the guardians are selected in order of the student attendance numbers of their children. The assigning unit 14 first selects the guardian of a student having student attendance number 21.

Next, the assigning unit 14 obtains all desired dates and times for all guardians for whom appointments have not yet been determined other than the selected guardian (S202). Guardians for whom appointments have not yet been determined are not only the guardian having the highest degree of priority, but also all guardians with all degrees of priority who have not yet been assigned a appointment. In the present embodiment, the assigning unit 14 obtains the second choice dates and times for guardians of students having attendance numbers 22 through 25, other than the guardians of students having attendance number 21.

Then, the assigning unit 14 provisionally assigns all of the desired dates and times of all of the guardians for whom appointments have not yet been determined obtained in S202 to the appointment slots (S204). At this time, the assigning unit 14 provisionally assigns guardians to appointment slots for all of the dates in the case that the date of their second choice is “no specific date”, and provisionally assigns guardians to appointment slots for all times when the time of their second choice is “no specific time”.

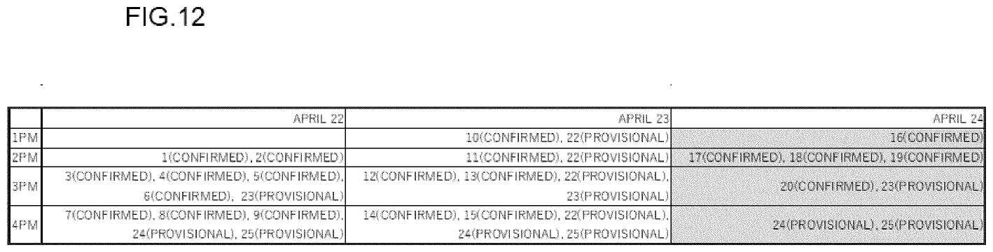

Specifically, for example, the second choice date of the guardian of a student having attendance number 22 is 4/23 and the time is “no specific time,” as illustrated in FIG. 12. Therefore, appointments for the guardian of the student having attendance number 22 are provisionally assigned to appointment slots for all of the times on 4/23. In FIG. 12, student attendance numbers which have already been confirmed are marked with (confirmed), and student attendance numbers which have been provisionally assigned appointments are marked with (provisional).

Similarly, second choice date of the guardian of a student having attendance number 23 is “no specific date” and the time is 3:00 p.m. Therefore, appointments for the guardian of the student having attendance number 23 are provisionally assigned to the 3:00 p.m. appointment slot for all dates, as illustrated in FIG. 12. The second choices of the remaining guardians of students having attendance numbers 24 and 25 are provisionally assigned appointments in the same manner. FIG. 12 illustrates the provisional assignment of appointments for all second choice dates and times for guardians of students having attendance numbers 22 through 25.

Next, the assigning unit 14 calculates a projected number of assignments for each appointment slot, by adding the number of guardians with confirmed appointments and the number of guardians with provisionally assigned appointments (S206).

The assigning unit 14 then identifies the appointment slot with the lowest projected number of assignments from among the second choice dates and times of the guardian selected in S200, and assigns appointments for the selected guardian to the identified slot (S208).

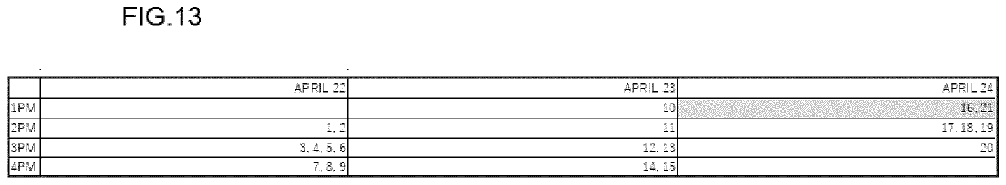

Specifically, the date and time of the second choice of the guardian of the student having attendance number 21 is 4/24 and “no specific time”. Therefore, the projected number of assignments for all time slots on 4/24 illustrated in FIG. 12 is confirmed. The appointment for the guardian of the student having attendance number 21 is assigned to the appointment slot at 1:00 p.m. with the lowest projected number of assignments. FIG. 13 illustrates a state in which the appointment of the guardian of the student having attendance number 21 is assigned in the table illustrated in FIG. 11a.

In the case that the assigning unit 14 is unable to confirm an appointment for the selected guardian in S210 (S210, NO), specifically, in the case that appointments for four guardians have already been confirmed for the appointment slot with the lowest projected number of assignments, the assigning unit 14 checks whether it is possible to assign appointments for all of the desired appointment slots in order from the lowest number of assignments. If appointments for four guardians have already been confirmed for all of the desired appointment slots, an appointment is provisionally assigned to the appointment slot at the first choice date and time of the selected guardian (S212).

In contrast, in the case that the assigning unit 14 is able to confirm an appointment for the selected guardians (S210, YES), that is, in the case that an appointment can be confirmed in one of the desired appointment slots of the selected guardians, the assigning unit 14 confirms whether any guardians who were extracted at S110 for whom appointments have not yet been determined and who were not selected at S200 exist (S214). In the case that guardians for whom appointments have not yet been determined exist (S214, NO), the assigning unit 14 returns to S200 and select the next guardian in the order. Specifically, the guardian of the student having attendance number 22 is selected.

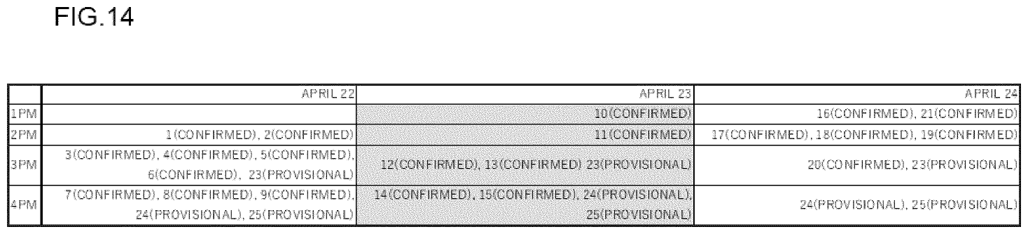

The assigning unit 14 then repeats the processes from S202 through S212. Specifically, the assigning unit 14 obtains the second choice dates and times for all guardian of students having attendance numbers 23 through 25 other than the selected guardian of the student having attendance number 22, and provisionally assigns appointments for the obtained dates and times. FIG. 14 illustrates the provisionally assigned appointments for the second choice dates and times for the guardian of students having attendance numbers 23 through 25.

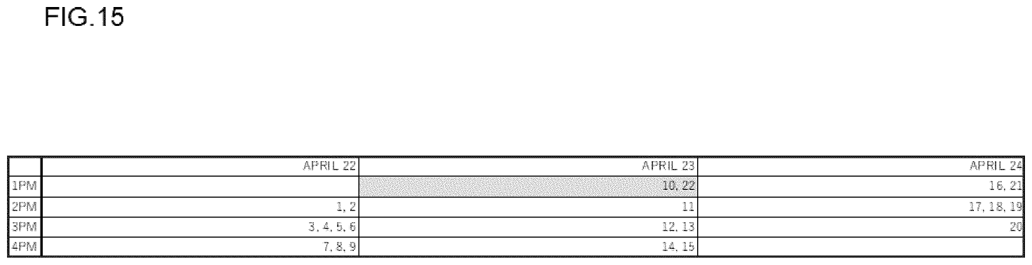

Then, the assigning unit 14 identifies the appointment slot with the lowest number of projected assignments from among the second choice dates and times of the guardians having the student having attendance number 22 selected in S200, and assigns the appointment for the selected guardian of the student having attendance number 22 to the identified appointment slot. Specifically, since the date of the second choice of the guardian of the student having attendance number 22 is 4/23 and the time is “no specific time,” the projected numbers of assigned appointments for all of the time slots on 4/23 illustrated in FIG. 14 are checked, and the appointment for the guardian of the student having attendance number 22 is assigned to the appointment slot at 13:00, which has the lowest projected number of assignments. The two appointment slots with the lowest number of projected assignments among all of the time slots on 4/23 are at 13:00 and 14:00. In the case that there are a plurality of appointment slots with the lowest number of projected assignments, the appointment slot with the earlier time is selected, for example. FIG. 15 illustrates a state in which an appointment is assigned for the guardian of the student having attendance number 22 in the table illustrated in FIG. 13.

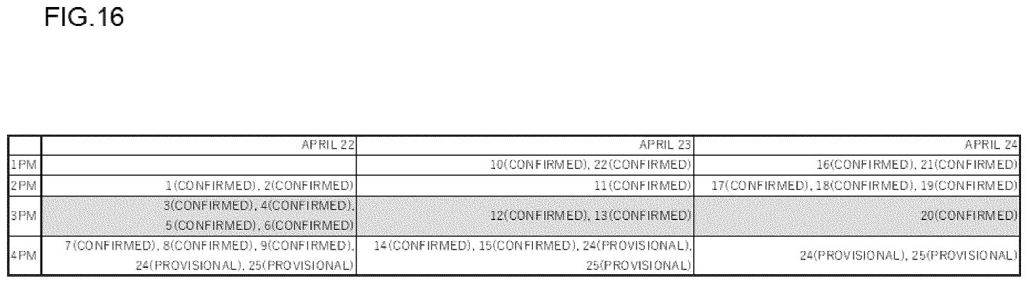

Next, the assigning unit 14 selects the guardian of the student having the next student attendance number 23, obtains the second choice dates and times for the guardians of students with student attendance numbers 24 and 25 other the guardian of the student having attendance number 23, and provisionally assigns appointments for the obtained dates and times. FIG. 16 illustrates a state in which appointments are provisionally assigned to the second choice dates and times for all of the guardians of students having attendance numbers 23 through 25. Then, the assigning unit 14 identifies the appointment slot with the lowest number of projected assignments from among the second choice dates and times for the guardian of the student having attendance number 23 selected in S200, and assigns an appointment for the selected guardian of the student having attendance number 23 to the identified appointment slot.

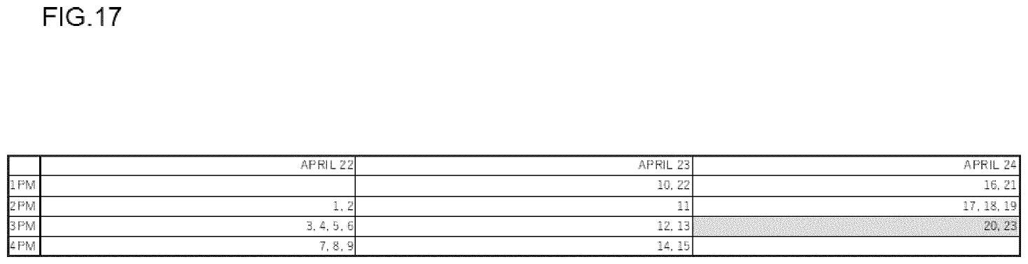

Specifically, the date of the second choice of the guardian of the student having attendance number 23 is “no specific date” and the time is 3:00 p.m. Therefore, the projected number of assignments for the 3:00 p.m. slots for all of the dates illustrated in FIG. 16 are checked, and an appointment for the guardian of student having attendance number 23 is assigned to the 3:00 p.m. slot on 4/24 with the lowest projected number of assignments. FIG. 17 illustrates a state in which the appointment of the guardian of the student having attendance number 23 is assigned in the table illustrated in FIG. 15.

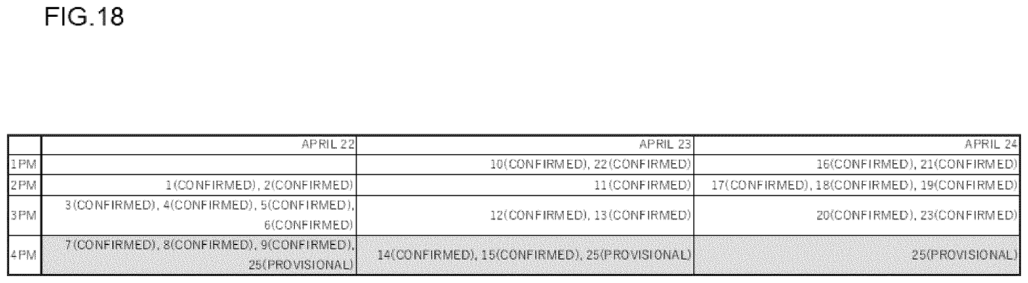

Next, the assigning unit 14 selects the guardian of the student having the next student attendance number 24, obtains the second choice date and time for the guardian of the student having attendance number 25 other than the guardian of the student having attendance number 24, and provisionally assigns an appointment for the obtained date and time. FIG. 18 illustrates the provisionally assigned appointment for the second choice date and time of the guardian of the student having attendance number 25. Then, the assigning unit 14 identifies an appointment slot with the lowest predicted number of assignments among the second choice dates and times for the guardian of the student having attendance number 24 selected in S200, and assigns an appointment for the selected guardian of the student having attendance number 24 to the identified appointment slot.

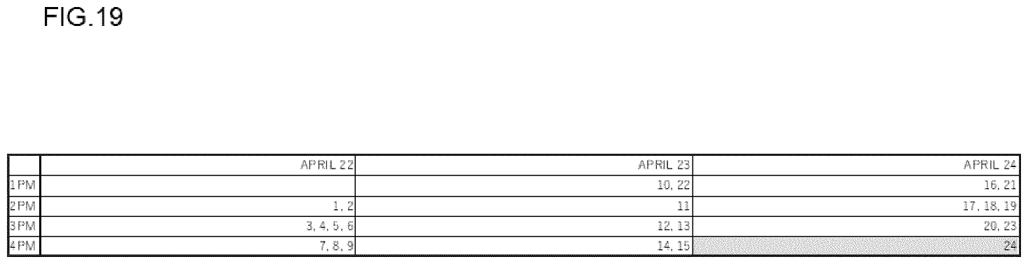

Specifically, the date and time of the second choice of the guardian of the student having attendance number 24 are “no specific date” and 4:00 p.m. Therefore, the projected number of assignments for the 4:00 p.m. appointment slots for all dates illustrated in FIG. 18 are checked, and an appointment for the guardian of the student having attendance number 24 is assigned to the 4:00 p.m. appointment slot on 4/24 with the lowest projected number of assignments. FIG. 19 illustrates a state in which the appointment of the guardian of the student having attendance number 24 is assigned to the table illustrated in FIG. 17.

Next, the assigning unit 14 selects the guardian of the last student having attendance number 25, and since there are no guardians other than the guardian of the student having attendance number 25, the processes from S202 through S208 are not performed. The assigning unit 14 identifies the appointment slot with the smallest number of guardians with confirmed appointments from among the second choice dates and times of the guardian of the student having attendance number 25, and assigns an appointment for the guardian of the student having attendance number 25 to the identified appointment slot.

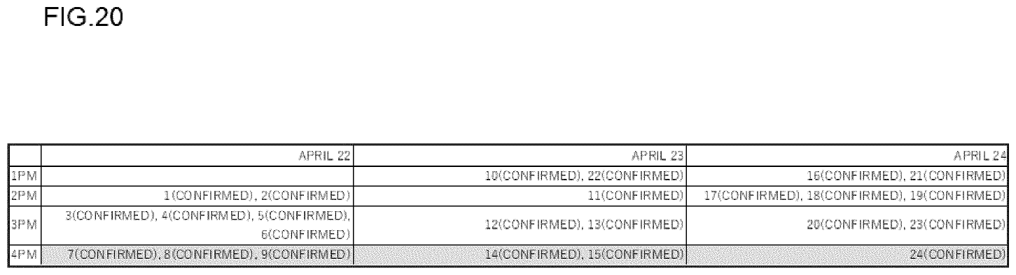

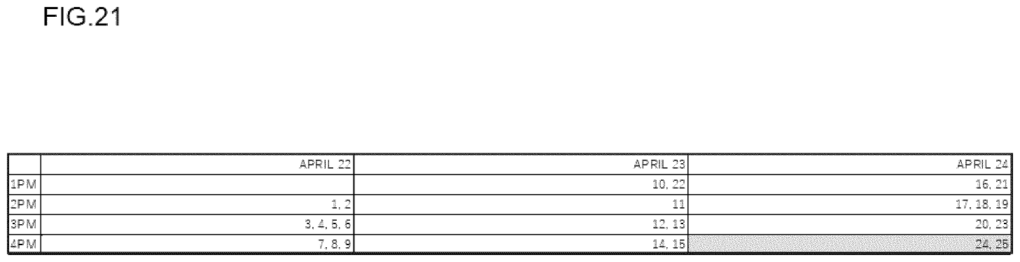

Specifically, the date and time of the second choice of the guardian of the student having attendance number 25 are “no specific date” and 4:00 p.m. Therefore, the number of guardians with confirmed appointments for the 4:00 p.m. appointment slots for all dates illustrated in FIG. 20 is checked, and the appointment for the guardian of the student having attendance number 25 is assigned to the 16:00 appointment slot on 4/24 with the lowest projected number of assignments. At this time, if four guardians have confirmed appointments for all of the appointment slots for the second choice date and time for the guardian of the student having attendance number 25, the appointment is provisionally assigned to the first choice date and time of the guardian of the student having attendance number 25. FIG. 21 illustrates a state in which the appointment of the guardian of the student having attendance number 25 is assigned to the table illustrated in FIG. 19.

In the case that at S214, the assigning unit 14 confirms that there are no guardians extracted at S110 who have not yet been selected at S200 (S214, YES), the process returns to the flowchart illustrated in FIG. 8 and checks whether processes S98 to S114 have been completed for guardians having all degrees of priority (S114). In the case that processes S98 to S114 have not been completed for guardians having all degrees of priority (S114, NO), a guardian having the next highest degree of priority is extracted (S116). The assigning unit 14 then replaces the guardian having the highest degree of priority with the guardian having the next highest degree of priority and repeats the process from S98 to S116.

In the case that the assigning unit 14 confirms at S114 that the process from S98 to S114 has been completed for guardians having all degrees of priority, it extracts guardians for whom appointments have not yet been confirmed (S118). The guardians extracted at S118 are those who selected both “no specific date” and “no specific time”. Then, the assigning unit 14 repeats the processes of subroutine A again for the guardians who selected both “no specific date” and “no specific time” (S120).

Then, in the case that the assignment of appointments for all guardians is completed (including the provisional appointments for the first desired date mentioned above) in S214 of subroutine A (S214, YES), the assigning unit 14 identifies appointment slots having over the capacity of four guardians and displays them on the terminal device of the teacher and prompts the teacher to adjust the schedule manually. Then, the teacher manually adjusts the schedule such that appointment slots having over the capacity of four guardians employing the terminal equipment so that there are no more overassigned slots (S122).

The assigning unit 14 then sends the assigned appointment slots to each of the terminal devices 20 of the guardians (S124).

By assigning appointments to guardians who specified any given date and time in the manner described above, the appointments can be assigned evenly among the entirety of appointment slot.

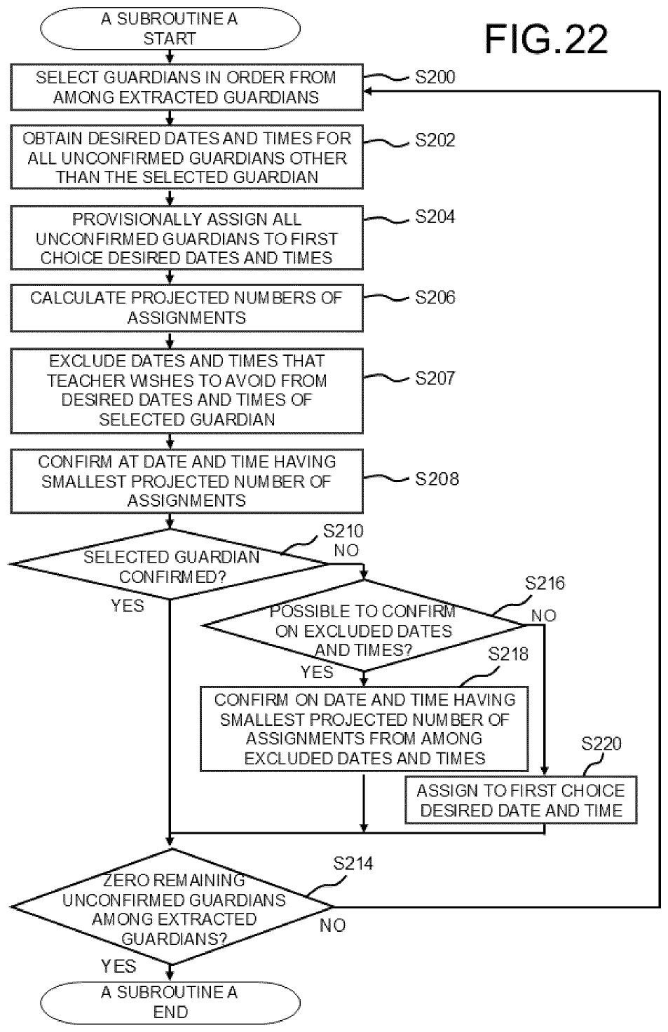

The above is a description of how appointments are assigned in the case that a guardian selects “no specific date” and/or “no specific time” as the desired appointment slot. However, but there may be cases in which there are time slot to be avoided if there are no guardians who wish to have a specific date and time due to the circumstances of the teacher. In such cases, scheduling that takes the teacher's wishes into consideration as described above will be described with reference to the flow chart illustrated in FIG. 21. Since the flowchart illustrated in FIG. 22 is a variation of Subroutine A illustrated in FIG. 10, the description will focus on points that differ from the description of Subroutine A above.

In the variation of subroutine A, after obtaining the projected number of assignments in S206, the assigning unit 14 excludes the date and time that the teacher wishes to avoid from the guardians' second choice dates and times selected in S200 (S207).

Next, the assigning unit 14 identifies the appointment slot with the lowest projected number of assignments among the dates and times that exclude the date and time the teacher wishes to avoid from the second choices of the guardians selected in S200, and assigns the appointment for the selected guardians to the identified slot (S208).

In the case that the assigning unit 14 is unable to confirm appointments for the selected guardians in S210 (S210, NO), specifically, if appointments for four guardians have already been confirmed for the appointment slot with the lowest projected number of assignments, the assigning unit 14 checks whether it is possible to assign appointments for all of the desired appointment slots in order from the lowest number of assigned appointments. If appointments for four guardians have already been confirmed for all of the desired appointment slots, the assigning unit 14 checks whether the appointments can be confirmed for the dates and times which were excluded in S207 (S216).

In the case that appointments can be confirmed for the date and time excluded in S207 (S216, YES), the assigning unit 14 identifies the date and time with the lowest projected number of assignments among the excluded assignable dates and times, and assigns appointments for the selected guardians to the identified date and time (S218).

In contrast, in the case that the assigning unit 14 is unable to confirm appointments for the selected guardians in S216 (S216, NO), specifically, if appointments cannot be confirmed even for the dates and times excluded by the teacher, the assigning unit 14 provisionally assigns appointments to appointment slots at the first choice dates and times of the selected guardians (S220).

In addition, in the case that the assigning unit 14 is able to confirm appointments for the selected guardians in S210 (S210, YES), that is, in the case that appointments are capable of being confirmed in one of the appointment slots desired by the selected guardians, the processes are the same as the processes of subroutine A described above.

By assigning appointments by excluding dates and times that the teacher wants to avoid, as described above, scheduling can be conducted taking the circumstances of the teacher into consideration.

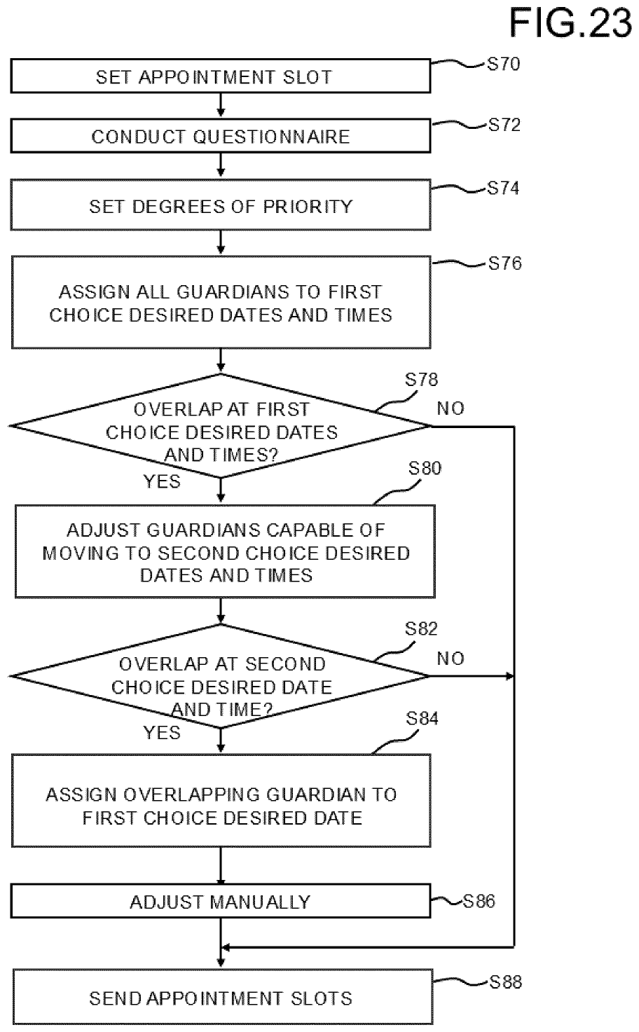

A method of assigning appointments with degrees of priority of guardians being prioritized over the desired appointment slots of the guardians has been described above. Next, a method of assigning appointments with the desired appointment slots of the guardians prioritized over the degrees of priority of the guardians will be described with reference to the flowchart illustrated in FIG. 23.

First, the processes from setting the appointment slots to setting the degree of priority of each guardian (S70 through S74) are the same as those of S40 through S44 in the flowchart illustrated in FIG. 7.

Next, the assigning unit 14 first assigns an appointment for each guardian at the appointment slots of the first choice dates and times for all of the guardians (S76).

Then, the assigning unit 14 determines whether the first choice dates and times overlap among the guardians (S78). In the case that the first choice dates and times overlap among the guardians (S78, YES), the assigning unit 14 identifies the second choice dates and times of the overlapping guardians, and if there is a guardian who can be moved to their second choice date and time (an appointment for another guardian is not assigned to the appointment slot as their first choice date and time), the assignment unit 14 moves and assigns the appointment for the guardian to the second choice date and time and (S80). In this case, if all overlapping guardians can be moved to their second choice date and time, the appointment for the first choice date and time is assigned to the guardian having the highest degree of priority among the guardians, and the other guardians are moved to their second choice dates and times. If there is no overlap among a plurality of guardians in S78 (S78, NO), the assigning unit 14 proceeds to S88 to be described below, and sends the appointment slots to each guardian.

Then, the assigning unit 14 determines whether the second choice dates and times overlap among guardians in the case that the second choice dates and times are adjusted in S80 (S82). In the case that the second choice dates and times overlap among guardians (S82, YES), the assigning unit 14 reassigns the first choice dates and times as provisional appointments for the overlapping guardians (S84). That is, at this point in time, there are a plurality of overlapping guardians at their first desired dates and times. Cases in which there are a plurality of overlapping guardians in S82 include a case in which a guardian has already made an appointment for their first choice date and time for the second choice date and time of another guardian, or a case where the second choice date and time overlap among guardians. If the second choice dates and times overlap among guardians, the appointment for the guardian having the highest degree of priority is assigned to their second choice date and time, and the appointment for the other guardian is reassigned to their first choice date and time. In addition, in the case that there is no overlap among multiple guardians at S82 (S82, NO), the assigning unit 14 proceeds to S88 to be described below, and sends the appointment slots to each guardian.

After the assignment of appointments for all of the guardians at their first or second choice dates and times has been completed as described above (including the assignment of provisional appointments as described above), the assigning unit 14 identifies the appointment slots that overlap for a plurality of guardians, and displays those appointment slots on the teacher's terminal device to prompt manual adjustment. The teacher then uses the terminal device to manually adjust the appointment slots such that the overlapping slots are eliminated (S86).

The assigning unit 14 then sends the appointment slots for which the appointments were assigned to each of the terminal devices 20 of the guardians (S88).

By assigning appointments in the manner described above, the scheduling of appointments can be conducted with priority given to the desired appointment slots of guardians.

Note that in the case that a guardian is not assigned to a given appointment slot in the scheduling according to the flowchart illustrated in FIG. 8, all appointments for the guardians will be manually adjusted by the teacher employing a terminal device.

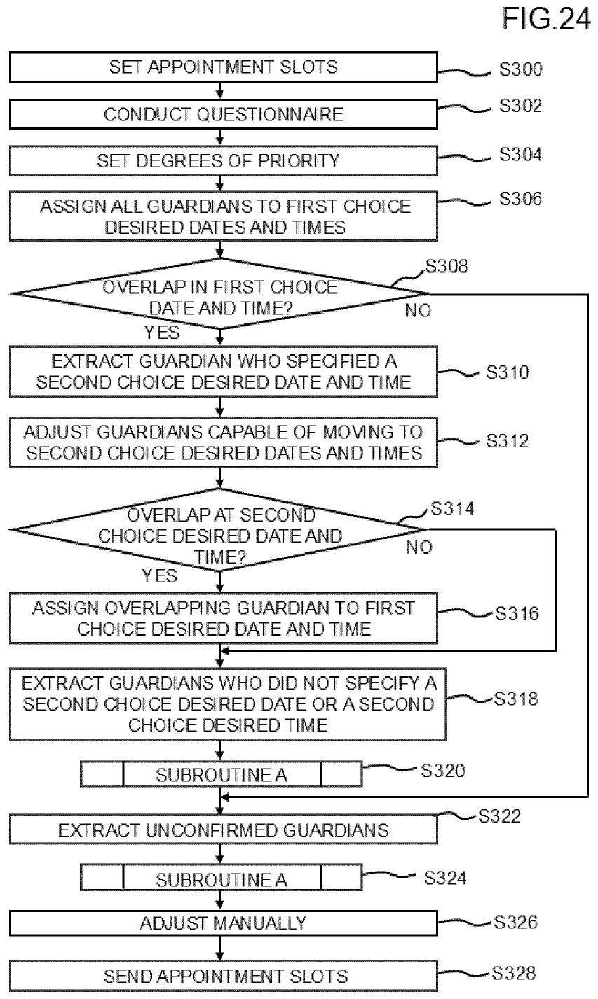

Next, in the method described above for assigning appointments by giving priority to the desired appointment slots of guardians over the degrees of priority of guardians, the guardian may select “no specific date” and/or “no specific time” in the same manner as in the scheduling that prioritizes degrees of priority. In such cases, subroutine A can be executed to assign appointments in the same manner as in the scheduling that prioritizes degrees of priority. FIG. 24 illustrates a flowchart for executing subroutine A in the method of assigning appointments by giving priority to the desired appointment slots of guardians over the degrees of priority of the guardians.

First, the processes from setting the appointment slots to assigning an appointment to the first choice date and time of the guardian having the highest degree of priority (S300 through S308) are similar to those of S70 through S78 in the flowchart illustrated in FIG. 23. However, when conducting the questionnaire in S302, the guardians always specify a specific date and time for their first choice, but can select “no specific date” or “no specific time” for their second choice.

Then, the assigning unit 14 assigns the appointment at the first choice dates and times for all of the guardians in S306. Then, the assigning unit 14 determines whether there is overlap among the guardians when appointments are assigned at the first choice dates and times for all of the guardians (S308). In the case that there is no overlap among the guardians when appointments are assigned at the first choice dates and times (S308, NO), the process proceeds to S322 to be described below after assigning the appointments.

In contrast, in the case that there is overlap among the guardians when appointments are assigned at the first choice dates and times (S308, YES), the assigning unit 14 checks the second choice dates and times of the overlapping guardians, calculates the number of remaining appointments (number of people) for the second choice date and time specified by each guardian, identifies the guardian with the lowest total number of remaining appointments (number of people), and assigns the appointment for the first choice date and time to the identified guardian. Note that in the case that “no specific date” or “no specific time” is selected as the date or time of the second choice when calculating the number of slots remaining for the second choice date and time, all applicable slots will be added to the number of slots remaining (number of people).

The assigning unit 14 then extracts guardians who were not assigned a appointment at the dates and times of their first choice in the processes of S306 through S308 and who have specified both specific dates and times as their second choices (S310). The assigning unit 14 then makes adjustments at the second choice dates and times for the extracted guardians (S312).

Specifically, the assigning unit 14 determines whether there is overlap among guardians when appointments are assigned to the second choice dates and times of the guardians extracted in S310 (S314).

In the case that there is no overlap among guardians when the appointments are assigned to the second choice dates and times (S314, NO), the assigning unit 14 assigns the appointments at the second choice dates and times for the guardians extracted in S310, and then proceeds to S318, to be described below.

In contrast, in the case that there is overlap among the guardians extracted in S310 when the appointments are assigned to the second choice dates and times (S314, YES), the assignment unit 14 assigns appointments to the overlapping guardians again at their first choice date and time as provisional appointments (S316). That is, at this point in time, there are a plurality of overlapping guardians at their first choice dates and times. Note that cases in which a plurality of guardians overlap in S314 include a case in which another guardian has already made an appointment for their first choice date and time for the second choice date and time, or a case in which the second choice dates and times overlap among guardians. If the second choice dates and times overlap with those of other guardians, the appointment for one of the guardians is assigned to their second choice date and time, and the appointment for the other guardians is reassigned to their first choice date and time.

That is, for guardians who have specified specific dates and times up to their second choice at the steps of the process up to S316, the assigning unit 14 assigns an appointment at the dates and times of their first or second choices (including provisional appointments at their first choice dates and times).

Next, the assigning unit 14 extracts guardians who have not been assigned an appointment on their first choice dates and times and who have not specified a specific date or time in their second choice, based on the results of the questionnaires which were answered by the guardians (S318).

Then, the assigning unit 14 performs subroutine A to assign appointments for the guardians who selected “no specific date” or “no specific time” extracted in S318 (S320). The processes of subroutine A are the same as those described with reference to the flow chart illustrated in FIG. 10.

In the case that the assigning unit 14 confirms that there are no guardians who were extracted in S318 who have not yet been selected in S200 at S214 of subroutine A (S214, YES), it returns to the flowchart illustrated in FIG. 24 and extracts guardians for whom appointments have not yet been confirmed (S322). The guardians extracted in S322 are those who selected both “no specific date” and “no specific time”. Then, the assigning unit 14 repeats the processes of subroutine A again for the guardians who selected both “no specific date” and “no specific time” (S324).

Then, if the assignment of appointments for all guardians is completed (including provisional appointments for the first choice date and time described above) at S214 of subroutine A (S214, YES), the assigning unit 14 identifies appointment slots that are over the capacity of four guardians and displays them on the teacher's terminal device to prompt the teacher to adjust the schedule manually. Then, the teacher manually adjusts the appointment slots that are over the capacity of four guardians employing the terminal equipment so that there are no more overassigned slots (S326).

The assigning unit 14 then sends the appointment slots assigned to each of the terminal devices 20 of the guardians (S328).

By assigning appointments for guardians for any given date and time as described above, appointments can be assigned evenly throughout the entirety of the appointment slots.

Note that the variation of subroutine A illustrated in FIG. 22 can also be applied to subroutine A illustrated in FIG. 23, and scheduling can take dates that the teacher wishes to exclude into consideration.

Note that the appointment management system 1 of the above embodiment is an example in which the present disclosure is applied to appointments for meetings between teachers and guardians. However, the present disclosure is not limited to such a configuration, and may be employed to determine other appointments. The present disclosure may be applied to appointments at hospitals, reservations at restaurants, and reservations for tickets, for example.

In the case that the present disclosure is applied to appointments at a restaurant, for example, the appointment slots are set to the restaurant's business hours on a given day. Then, information such as whether a guest is a first time customer or a repeat customer, the number of repeat visits and the amount of money spent so far if the guest is a repeat customer, and a budget proposed by the first time customer may be employed as attribute information of the guest, for example. Appointment slots are assigned based on such attribute information. Specifically, repeat customers may be assigned appointments with a higher degree of priority over first time customers, repeat customers with a high number of repeat visits and customers who have spent a high amount of money may be assigned appointment with a higher degree of priority as important customers, and first time customers who propose higher budgets may be assigned appointments with a higher degree of priority. In addition, the restaurant may set degrees of priority based on the information described above, and appointments may be assigned based on the set degrees of priority.

In addition, in the case that the present disclosure is applied to appointments at a hospital, for example, appointment slots are set for each department. Then, whether a guest is a first time patient or a repeat patient, the urgency of the hospital visit, and whether the visit is expected to take time may be employed as attribute information of a guest, for example. Appointment slots are assigned based on such attribute information. Specifically, if a first time patients may be prioritized over repeat patients and be assigned longer visit times, and patients having higher degrees of urgency may be prioritized to be assigned appointments and visit times. In addition, appointments for visit times may be assigned to a greater degree for patients that require time for explanations.

Further, in the case that the present disclosure is applied to a ticket reservation system, for example, the appointment slot is set to the date and time of a performance. Then, information such as whether a guest is a first time customer or a repeat customer, the number of repeat reservations and the amount of money spent so far if the guest is a repeat customer, and in the case that tickets are drawn by lottery, information regarding the rate of winning or losing previous tickets may be employed as attribute information of a guest, for example. Appointment slots are assigned based on such attribute information. Specifically, first time customers or repeat customers may be assigned appointments with a higher degree of priority, if a repeat guest has a rate of winning or losing less than a certain value, he or she may be given a higher degree of priority, and first time customers who propose higher budgets may be assigned reservations for tickets with a higher degree of priority.

Note that the present disclosure is not limited to the above embodiments, but may be realized by modifying the components to an extent that does not depart from the spirit thereof at the implementation stage. Also, various inventions may be formed by appropriate combinations of the plurality of components disclosed in the above embodiments. For example, all of the components described in the embodiments may be combined as appropriate. It is, of course, possible to make various modifications and applications within the scope that does not depart from the spirit of the disclosure.

The following items are further disclosed with respect to the present disclosure.

### (Item 1)

An appointment management apparatus of the present disclosure is equipped with an appointment slot setting unit in which a plurality of appointment slots prepared by a host are set in advance, a guest attribute information storage unit in which attribute information of a plurality of guests who make appointments for a plurality of appointment slots is stored, a desired appointment slot receiving unit that receives desired appointment slots of the plurality of guests, and an assigning unit that assigns appointments for each guest from among the plurality of appointment slots based on the desired appointment slot of each guest and the attribute information of each guest.

### (Item 2)

In the appointment management apparatus of Item 1, the assignment unit may notify a terminal device of a guest for whom a desired appointment slot cannot be assigned of a request to change their desired appointment slot, reassigns an appointment slot based on a desired appointment slot which is changed in response to the request for a change, and repeats the notification of the request for a change and reassignment until the assignment of appointment slots to all guests is completed.

### (Item 3)

In the appointment management apparatus of Item 1 or 2, the assignment unit may add priority appointment information to the guest who has changed their desired appointment slot, giving priority in the assignment of appointment slots for a next and subsequent appointments.

### (Item 4)

In the appointment management apparatus of any of Items 1 through 3, the guest attribute information may be set based on an evaluation of a guest.

### (Item 5)

In the appointment management apparatus of any of Items 1 through 4, the host may be a school, the guest may be a guardian of a student who attends the school, and the appointment slot may be an appointment slot for a meeting between a school teacher and the guardian.

### (Item 6)

In the appointment management apparatus of Item 5, the guest attribute information may be set based on an evaluation of the student or the guardian.

### (Item 7)

In the appointment management apparatus of Item 1, the guest attribute information may be a degree of priority which is set in advance for the guest by the host, and the assigning unit may assign an appointment for each guest with the degree of priority having priority over the desired appointment slot of the guest.

### (Item 8)

In the appointment management apparatus of Item 7, the assignment unit, when assigning appointments to each guest based on the desired appointment slots of guests with the same degree of priority, extracts guests who have specified any date and time as the desired appointment slots, selects guests among the extracted guests who are targets of assignment to appointment slots, provisionally assigns appointments to the appointment slots based on the desired appointment slots of all guests for whom appointments have not been assigned yet other than guests who are targets of assignment to appointment slots, and assigns appointments to the guests who are targets of assignment to appointment slots based on the number of such provisionally assigned appointments.

### (Item 9)

In the appointment management apparatus of Item 1, the guest attribute information may be a degree of priority of a guest which is set in advance by the host, and the assignment unit may assign an appointment for each guest with priority given to the desired appointment slot of the guest over the degree of priority of the guest.

### (Item 10)

In the appointment management apparatus of Item 9, the assignment unit may extract guests who have specified any date and time as the desired appointment slot of the guests, select guests who are targets of assignment to appointment slots from among the extracted guests, provisionally assign appointments to the appointment slots based on the desired appointment slots of all guests for whom appointments have not been assigned yet other than the guests who are targets of assignment to appointment slots, and assign appointments to the guests who are targets of assignment to appointment slots based on the number of such provisionally assigned appointments.

### (Item 11)

In the appointment management apparatus of Item 8 or 10, the assignment unit may assign an appointment for guests who are targets of assignment to appointment slots by excluding excluded slots which are set in advance by the host from among the appointment slots.

### (Item 12)

An appointment management system of the present disclosure is equipped with a appointment management apparatus of any of Items 1 through 10 and a terminal device of a guest.

### (Item 13)

An appointment management method of the present disclosure sets a plurality of appointment slots prepared by a host in advance, stores attribute information of a plurality of guests who are to make appointments from among the plurality of appointment slots in advance, receives desired appointment slots of the plurality of guests, and assigns an appointment for each guest from among the plurality of appointment slots based on the desired appointment slot of each guest and the attribute information of each guest.

### (Item 14)

An appointment management program of the present disclosure causes a computer to execute a step of setting a plurality of appointment slots prepared by a host in advance, a step of storing attribute information of a plurality of guests who are to make appointments from among the plurality of appointment slots in advance, a step of receiving desired appointment slots of the plurality of guests, and a step of assigning an appointment for each guest from among the plurality of appointment slots based on the desired appointment slot of each guest and the attribute information of each guest.

### EXPLANATION OF THE REFERENCE NUMERALS

1 appointment management system
10 appointment management apparatus
11 appointment slot setting unit
12 guest attribute information storage unit
13 desired appointment slot receiving unit
14 assigning unit
15 terminal device
21 control unit
22 display unit
23 input unit

What is claimed is:

1. An appointment management apparatus comprising:
an appointment slot setting unit in which a plurality of appointment slots prepared by a host are set in advance;
a guest attribute information storage unit that stores attribute information of a plurality of guests who make appointments from among the plurality of appointment slots;
a desired appointment slot receiving unit that receives desired appointment slots of the plurality of guests; and
an assigning unit that assigns an appointment for each guest from among the plurality of appointment slots based on the desired appointment slot of each guest and the attribute information of each guest.

2. The appointment management apparatus according to claim 1, wherein:
the assigning unit notifies the terminal device of a guest for whom a desired appointment slot cannot be assigned of a request to change their desired appointment slot, reassigns an appointment slot based on a desired appointment slot which is changed in response to the request for a change, and repeats the notification of the request for a change and reassignment until the assignment of appointment slots to all guests is completed.

3. The appointment management apparatus according to claim 2, wherein:
the assigning unit adds priority appointment information to a guest who has changed their desired appointment slot, that gives priority in the assignment of appointment slots for next and subsequent appointments.

4. The appointment management apparatus according to any of claim 1, wherein:
the attribute information of a guest is set based on an evaluation of the guest.

5. The appointment management apparatus according to claim 1, wherein:
the host is a school,
the guest is a guardian of a student attending the school, and
the appointment slot is an appointment slot for a meeting between a school teacher and a guardian.

6. The appointment management apparatus according to claim 5, wherein:
the attribute information of the guest is set based on an evaluation of the student or the guardian.

7. The appointment management apparatus according to claim 1, wherein:
the guest attribute information is a degree of priority which is set in advance for the guest by the host; and
the assigning unit assigns an appointment for each guest with the degree of priority having priority over the desired appointment slot of the guest.

8. The appointment management apparatus according to claim 7, wherein:
the assignment unit, when assigning appointments to each guest based on the desired appointment slots of guests with the same degree of priority, extracts guests who have specified any date and time as the desired appointment slots, selects guests among the extracted guests who are targets of assignment to appointment slots, provisionally assigns appointments to the appointment slots based on the desired appointment slots of all guests for whom appointments have not been assigned yet other than guests who are targets of assignment to appointment slots, and assigns appointments to the guests who are targets of assignment to appointment slots based on the number of such provisionally assigned appointments.

9. The appointment management apparatus according to claim 1, wherein:
the guest attribute information is a degree of priority of a guest which is set in advance by the host; and
the assignment unit assigns an appointment for each guest with priority given to the desired appointment slot of the guest over the degree of priority of the guest.

10. The appointment management apparatus according to claim 9, wherein:
the assignment unit extracts guests who have specified any date and time as the desired appointment slot of the guests, selects guests who are targets of assignment to appointment slots from among the extracted guests, provisionally assigns appointments to the appointment slots based on the desired appointment slots of all guests for whom appointments have not been assigned yet other than the guests who are targets of assignment to appointment slots, and assigns appointments to the guests who are targets of assignment to appointment slots based on the number of such provisionally assigned appointments.

11. The appointment management apparatus according to claim 8, wherein:
the assignment unit assigns an appointment for guests who are targets of assignment to appointment slots by excluding excluded slots which are set in advance by the host from among the appointment slots.

12. The appointment management apparatus according to claim 10, wherein:
the assignment unit assigns an appointment for guests who are targets of assignment to appointment slots by excluding excluded slots which are set in advance by the host from among the appointment slots.

13. An appointment management system comprising:
the appointment management apparatus according to claim 1; and
a terminal device of a guest.

14. An appointment management method comprising:
setting a plurality of appointment slots prepared by a host in advance;
storing attribute information of a plurality of guests who make appointments from among the plurality of appointment slots in advance;
receiving desired appointment slots of the plurality of guests; and
assigning an appointment to each guest from among the plurality of appointment slots based on the desired appointment slot of each guest and the attribute information of each guest.

15. A non-transitory computer-readable recording medium containing an appointment management program that causes a computer to execute:
a step of setting a plurality of appointment slots prepared by a host in advance;
a step of storing attribute information of a plurality of guests who make appointments from among the plurality of appointment slots in advance;
a step of receiving desired appointment slots of the plurality of guests; and
a step of assigning an appointment to each guest from among the plurality of appointment slots based on the desired appointment slot of each guest and the attribute information of each guest.
